(19) United States
(12) Patent Application Publication
(10) Pub. No.: US 2017/0289766 A1
(43) Pub. Date: Oct. 5, 2017

(54) Digital Assistant Experience based on Presence Detection

(71) Applicant: Microsoft Technology Licensing, LLC, Redmond, WA (US)

(72) Inventors: James William Scott, Cambridge (GB); Tobias Alexander Grosse-Puppendahl, Cambridge (GB); Alice Jane Bernheim Brush, Bellevue, WA (US); Joseph Spencer King, Seattle, WA (US); Diego Hernán Carlomagno, Redmond, WA (US); Konstantinos Aisopos, Kirkland, WA (US); Matthias Baer, Seattle, WA (US)

(73) Assignee: Microsoft Technology Licensing, LLC, Redmond, WA (US)

(21) Appl. No.: 15/377,677

(22) Filed: Dec. 13, 2016

Related U.S. Application Data
(60) Provisional application No. 62/314,887, filed on Mar. 29, 2016.

(51) Int. Cl. H04W 4/02; H04W 52/02; H04W 8/00

(52) U.S. Cl. CPC H04W 4/028; H04W 4/023; H04W 8/005; H04W 52/0209

(57) ABSTRACT

Techniques for digital assistant experience based on presence sensing are described herein. In implementations, a system is able to detect user presence and distance from a reference point, and tailor a digital assistant experience based on distance. The distance, for example, represents a distance from a client device that outputs various elements of a digital assistant experience, such as visual and audio elements. Various other contextual factors may additionally or alternatively be considered in adapting a digital assistant experience.

### PRIORITY

This application claims priority under 35 U.S.C. Section 119(e) to U.S. Provisional Patent Application No. 62/314,887, filed Mar. 29, 2016 and titled “Low-Power Speech Interaction with Presence Sensors,” the entire disclosure of which is hereby incorporated by reference.

### BACKGROUND

A variety of kinds of computing devices have been developed to provide computing functionality to users in different settings. For example, a user may interact with a mobile phone, tablet computer, wearable device or other computing device to compose email, surf the web, edit documents, interact with applications, and access other resources. Digital assistants for computing devices are widely used to help with various interactions like scheduling, making calls, setting reminders, navigating content, searching, and getting answers to questions. To be responsive, the device generally has to remain alert, but this consumes processing and battery power. Additionally, if the device is in a low-power-mode, latency is added to the digital assistant response since the system has to wake from a low-power mode.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for digital assistant experience based on presence sensing are described herein. In implementations, a system is able to detect user presence and distance from a reference point, and tailor a digital assistant experience based on distance. The distance, for example, represents a distance from a client device that outputs various elements of a digital assistant experience, such as visual and audio elements. Various other contextual factors may additionally or alternatively be considered in adapting a digital assistant experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment in accordance with one or more implementations.

FIG. 2 depicts an example scenario for adapting user experience in accordance with one or more implementations.

FIG. 3 depicts an example scenario for different proximity based interaction modalities in accordance with one or more implementations.

FIG. 4 depicts an example scenario for transfer of user experience between devices in accordance with one or more implementations.

FIG. 5 depicts an example scenario for adapting a user interface for user experience in accordance with one or more implementations.

FIG. 6 is a flow diagram of an example method for modifying a user experience based on user identity in accordance with one or more implementations.

FIG. 7 is a flow diagram of an example method for adapting a digital assistant experience based on sensor data in accordance with one or more implementations.

FIG. 8 is a flow diagram of an example method for transferring an aspect of a digital assistant experience between devices in accordance with one or more implementations.

FIG. 9 illustrates an example system that includes an example computing device that is representative of one or more computing systems and/or devices that may implement the various techniques described herein.

### DETAILED DESCRIPTION

Overview

Techniques for digital assistant experience based on presence sensing are described herein. In implementations, a system is able to detect user presence and distance from a reference point, and tailor a digital assistant experience based on distance. The distance, for example, represents a distance from a client device that outputs various elements of a digital assistant experience, such as visual and audio elements.

According to one or more implementations, techniques described herein are able to receive voice commands and react upon presence, identity and context of one or more people. By way of example, the described techniques can be implemented via a computing device equipped with one or multiple microphones, a screen, and sensors to sense the context of a user. Various sensors are contemplated including for example a camera, a depth sensor, a presence sensor, biometric monitoring devices, and so forth.

Aspects of digital assistant experience based on presence sensing include using presence sensing and other data collected via sensors to manage computing device states and adapt the visual experience based on factors including user presence, user identity, proximity of the user relative to the device, and context information such as the time of day, activities that are recognized, number of people present, and so forth.

According to various implementations, the power state of a computing device can be controlled based on sensing. This includes switching the computing device or particular components of the device on/off or between different power states/modes based on information gathered via the sensors. When the computing device is in an active state, a digital assistant system operates to process voice commands, and output appropriate graphical user interface (UI) visualizations and/or audible signals to indicate to a user that the digital assistant is ready and able to process voice and/or visual commands and other input. Based on user interaction, the digital assistant can respond to queries, provide appropriate information, offer suggestions, adapt UI visualizations, and takes actions to assist the user depending on the context and sensor data.

Various types of adaptations scenarios are contemplated. For instance, sensors may be used to obtain data for context sensing beyond a simple presence sensor, such as estimating the number of people present, recognizing the identities of people present, detection of distance/proximity to the people, and/or sensing when people approach or walk away from the device and/or other contextual sensors. For instance, different contextual factors can be sensed and/or inferred, such as age and/or gender based on visual information, a state a person is in (e.g., the user is able to see, talk, and so forth). Such contextual factors may be detected in various ways, such as via analysis of user motion, user viewing angle, eye tracking, and so on.

Further, system behavior (e.g., device power states and user experience) can be selectively adapted based on these and other factors. In another example, a microphone may be employed to measure loudness of the environment, and change the system behavior prior to receiving any voice input, such as by showing a prompt on the screen that changes when someone walks closer to a reference point.

Context sensors as noted above may also enable adaptations to the operation of a voice UI, such as responding differently based on whether multiple people are present or a single person, and responding differently based on proximity to a person. For example, when distance from a reference point to the person is relatively small, a graphical UI is considered appropriate and is therefore presented on a display screen. However, when the person is positioned such that the display screen may not be visible and/or the person is not looking at the display screen, the graphical UI may not be helpful in which case the system may utilize audible alerts, voice interaction, and audio responses.

Context sensors and techniques discussed herein may also be employed to improve accessibility scenarios. For example, the system may detect or be aware that a particular person is partially deaf. In this case, volume level may be adapted when that particular user is present. Likewise, the experience may be switched to an audio-based UI to accommodate someone who is blind or has some other visual impairment. Another example involves using simplified language and graphics for a child or someone with cognitive impairment. Additionally, when someone with a speech impediment is recognized or a foreign language is detected language models used by the system may be changed to better adapt to the user(s) in this scenario.

Thus, techniques described herein may conserve various system resources such as power and processing resources by reserving certain functionalities to contexts in which the functionalities are appropriate and/or likely to be used. For instance, processing and display functionalities can be powered off/hibernated until a user is detected to be in a location where the user may utilize the functionalities. Further, when a user is detected to leave the location, the resources may again be powered off/hibernated to preserve various system resources.

In the following discussion, an example environment is first described that is operable to employ techniques described herein. Next, some example implementation scenarios are presented in accordance with one or more implementations. Following this, some example procedures are discussed in accordance with one or more implementations. Finally, an example system and device that are operable to employ techniques discussed herein in accordance with one or more implementations.

Operating Environment

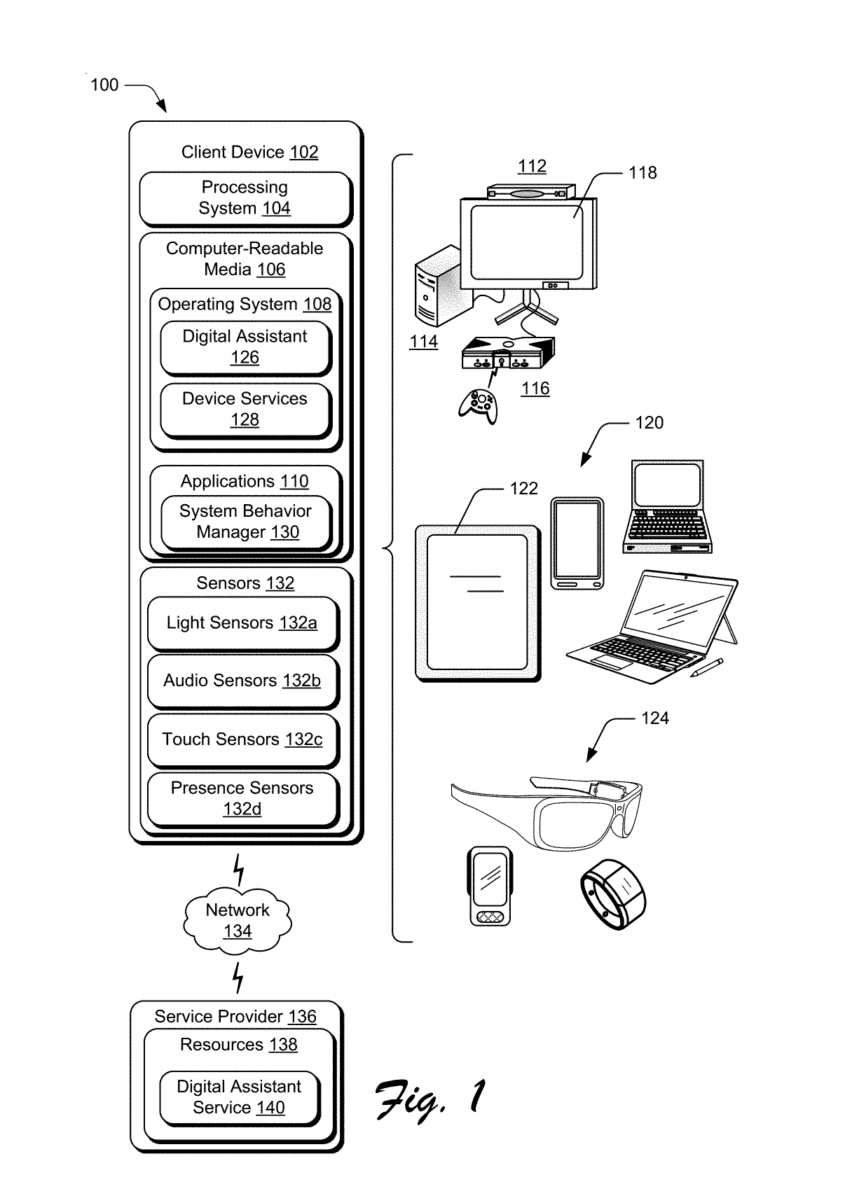

FIG. 1 illustrates an operating environment in accordance with one or more implementations, generally at 100. The environment 100 includes a client device 102 having a processing system 104 with one or more processors and devices (e.g., central processing units (CPUs), graphics processing units (GPUs), microcontrollers, hardware elements, fixed logic devices, and so forth), one or more computer-readable media 106, an operating system 108, and one or more applications 110 that reside on the computer-readable media 106 and which are executable by the processing system 104. Generally, the operating system 108 represents functionality for abstracting various resources of the client device 102 (e.g., hardware and logic resources) for access by other resources, such as the applications 110. The processing system 104 may retrieve and execute computer-program instructions from applications 110 to provide a wide range of functionality to the client device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

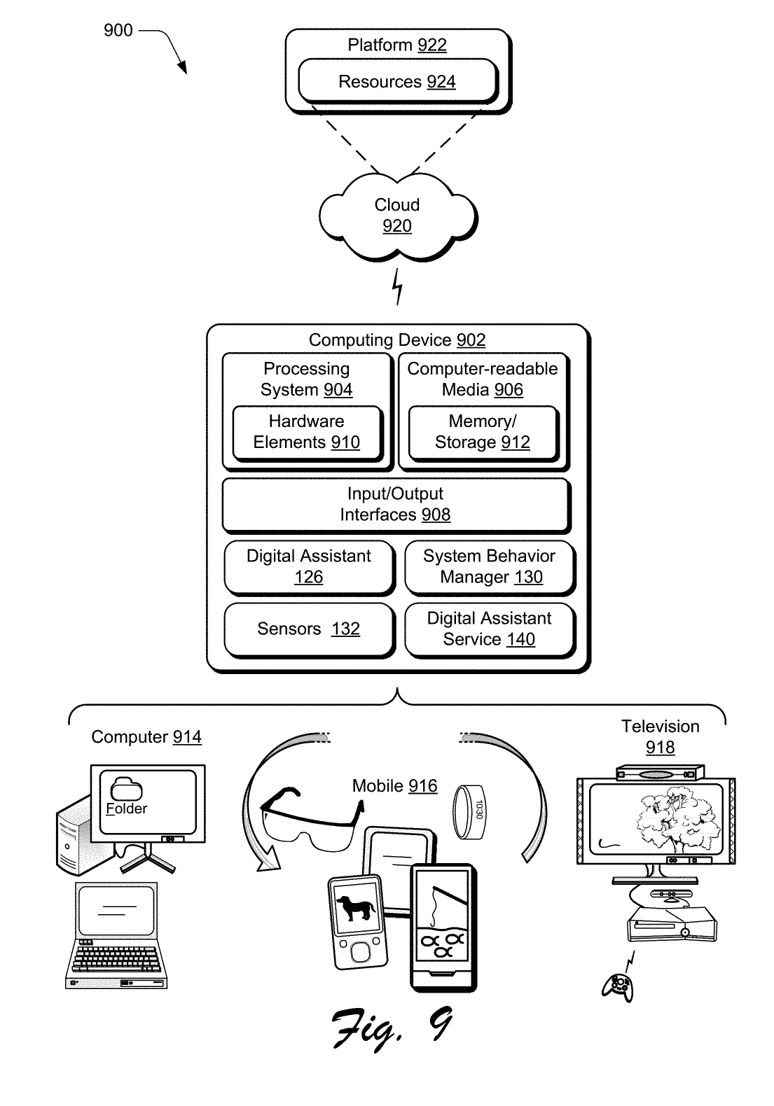

The client device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), a large-scale interactivity system, and so forth. For example, as shown in FIG. 1 the client device 102 can be implemented as a television client device 112, a desktop computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, and/or transported by a user. Examples of the wearable device 124 depicted in FIG. 1 include glasses, a smart band or watch, and a pod device such as clip-on fitness device, media player, or tracker. Other examples of the wearable device 124 include but are not limited to a ring, an article of clothing, a glove, and a bracelet, to name a few examples. One example of a computing system that can represent various systems and/or devices including the client device 102 is shown and described below in relation to FIG. 9.

The computer-readable media 106 can include, by way of example and not limitation, various forms of volatile and non-volatile memory and/or storage media that are typically associated with a computing device. Such media can include read-only memory (ROM), random access memory (RAM), flash memory, hard disk, removable media and the like. Computer-readable media can include both “computer-readable storage media” and “communication media,” examples of which can be found in the discussion of the example computing system of FIG. 9.

The client device 102 may include and/or make use of a digital assistant 126. In the illustrated example, the digital assistant 126 is depicted as being integrated with the operating system 108. The digital assistant 126 may additionally or alternatively be implemented as a stand-alone application, or a component of a different application such as a web browser or messaging client application. As yet another example, the digital assistant 126 may be implemented as a network-based service, such as a cloud-based service. The digital assistant 126 represents functionality operable to perform requested tasks, provide requested advice and information, and/or invoke various device services 128 to complete requested actions. The digital assistant 126 may utilize natural language processing, a knowledge database, and artificial intelligence to interpret and respond to requests in various forms.

For example, requests may include spoken or written (e.g., typed text) data that is interpreted through natural language processing capabilities of the digital assistant 126. The digital assistant 126 may interpret various input and contextual clues to infer the user's intent, translate the inferred intent into actionable tasks and parameters, and then execute operations and deploy device services 128 to perform the tasks. Thus, the digital assistant 126 is designed to act on behalf of a user to produce outputs that attempt to fulfill the user's intent as expressed during natural language interactions between the user and the digital assistant. The digital assistant 126 may be implemented using a client-server model with at least some aspects being provide via a digital assistant service component as discussed below.

In accordance with techniques described herein, client device 102 includes a system behavior manager 130 the represents functionality to control aspects of system behavior including device states, availability of the digital assistant 126, and an adaptations of user experience based on various factors. Generally, the system behavior manager 130 may be implemented as a software module, a hardware device, or using a combination of software, hardware, firmware, fixed logic circuitry, and so forth. The system behavior manager 130 may be implemented as a standalone component of the client device 102 as illustrated. In addition or alternatively, the system behavior manager 130 may be configured as a component of the digital assistant 126, the operating system 108, or other device application.

In at least some implementations, the system behavior manager 130 can utilize an auxiliary processor that is separate from the processing system 104, such as a dedicated processor. Alternatively or additionally, processing tasks for the system behavior manager 130 can be distributed between the processing system 104 and an auxiliary processor. In one particular implementation, an auxiliary processor for the system behavior manager 130 can be implemented as a processing subsystem of the processing system 104 such that primary portions of the processing system 104 can be powered-off or hibernated while the processing subsystem is running and analyzing data from sensors 132.

Generally, the client device 102 makes use of sensor data from various sensors 132 to obtain various inputs such as to detect user presence and/or other attributes of a user. The sensors 132, for instance, include light sensors 132a, audio sensors 132b, touch sensors 132c, and human presence sensors (“presence sensors”) 132d. Generally, these different sensors 132 may individually and/or in combination sense various phenomena such as user presence, user distance, user identity recognition, biometric attributes, sound (e.g., user speech and other sounds), along with other user and/or environmental attributes. Sensors 132 may alternatively or additionally detect other types of contextual information, such as user identity, time of day, user preferences, and so forth. Sensors may be included with the client device 102 and/or available from other connected devices, such as sensors associated with multiple computers in a home network, sensors on a user's phone, and so forth. A sensor and/or set of sensors 132, for instance, can be implemented as a dedicated sensor subsystem with dedicated a dedicated processor, storage, power supply, and so forth, that can detect various phenomena and communicate signals to the client device 102, such as a binary signal to wake the client device 102 from a sleep or off mode. The sensors 132, for instance, can actively detect various phenomena and contextual information while the processing system 104 is in a sleep mode. Generally, a dedicated sensor 132 may be implemented as part of the client device 102, and/or separately from the client device 132.

In this case, the client device 102 may communicate with and obtain sensor data from the connected devices over a network 134 and/or via a local or cloud service. For instance, different instances of the client device 102 can interconnect to share sensor data from sensors 132 that reside on the different respective devices. In an example implementation, different instances of the client device 102 can interconnect to form a mesh network such that sensor data from the sensors 132 can be shared, intelligence from different instances of the digital assistant 126 can be shared, and so forth.

According to various implementations, the system behavior manager 130 may operate under the influence of sensor data collected via the sensors 132 to perform various tasks, such as to manage and adapt power availability, device modes, digital assistant availability, power consumption, device component states, applications states, and so forth. The adaptations implemented via the system behavior manager 130 include selectively invoking, waking, and suspending the digital assistant 126 in dependence upon indications obtained from the sensors 132, such as user presence, identity, and/or proximity The adaptations additionally include selective modification to a user experience based on sensor data and context. For example, different user interface (UI) visualizations may be output for different recognized interactions scenarios, modes of interaction may be switched between visual-based and audio-based modes, customization of the user experience may be made based on user proximity and/or identity, and so forth. Further, the user experience may be dynamically adapted through the course of a particular action based on recognized changes, such as changes to number of users present, proximity, availability of secondary device/displays, lighting conditions, user activity, and so forth. User experience may also be adapted based on accessibility considerations, such as to accommodate various disabilities.

The environment 100 further depicts that the client device 102 is communicatively coupled via the network 134 to a service provider 136, which enables the client device 102 to access and interact with various resources 138 made available by the service provider 136. The resources 138 can include any suitable combination of content and/or services typically made available over the network 134 by various service providers. For instance, content can include various combinations of text, video, ads, audio, multi-media streams, animations, images, webpages, and so forth. Some examples of services that can be provided by the service provider 136 include, but are not limited to, an online computing service (e.g., “cloud” computing), an authentication service, web-based applications, a file storage and collaboration service, a search service, messaging services such as email, text and/or instant messaging, a social networking service, and so on.

Services may also include a digital assistant service 140. Here, the digital assistant service 140 represents server-side components of a digital assistant system (hereinafter “system”) that operates in conjunction with client-side components represented by the digital assistant 126. The digital assistant service 140 enables digital assistant clients to plug into various resources 138 such as search services, analytics, community-based knowledge, and so forth. The digital assistant service 140 can also populate updates across digital assistant client applications (e.g., the digital assistant 126), such as to update natural language processing and keep a knowledge database up-to-date.

Generally, the network 134 can be implemented in various ways, such as a wired network, a wireless network, combinations thereof, and so forth.

Having described an example operating environment, consider now some example implementation scenarios in accordance with one or more implementations.

Implementation Scenarios

The following section describes some example implementation scenarios for digital assistant experience based on presence sensing in accordance with one or more implementations. The implementation scenarios may be implemented in the environment 100 discussed above, and/or any other suitable environment.

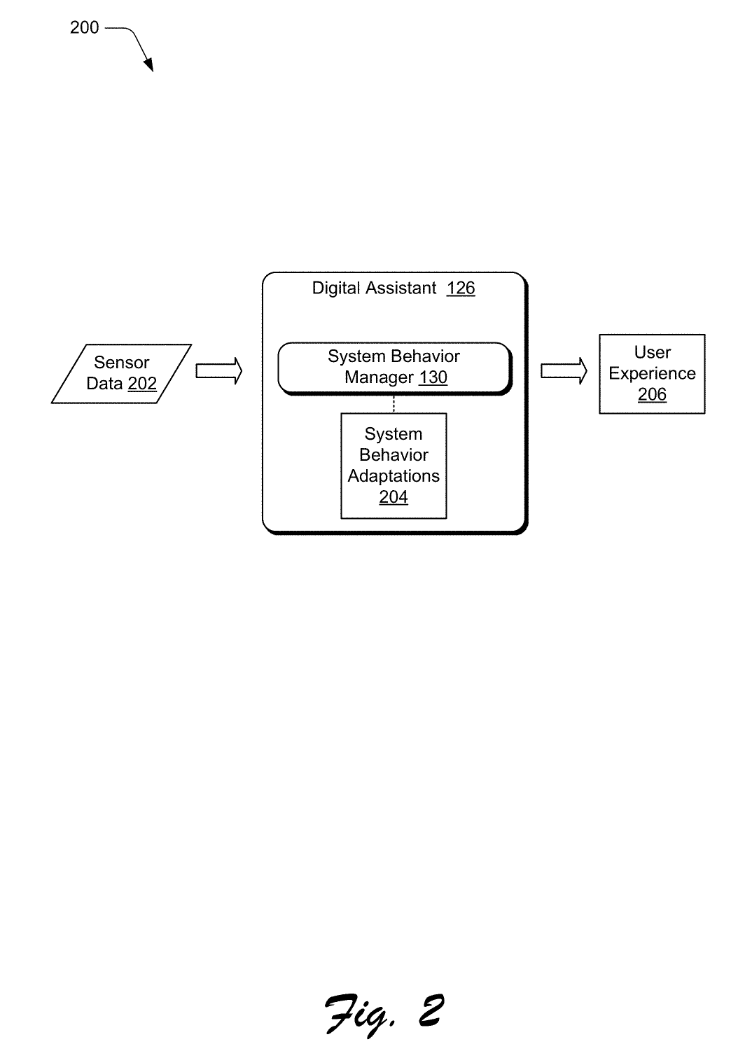

FIG. 2 depicts an example implementation scenario 200 for adapting user experience based on sensor data in accordance with one or more implementations. The scenario 200 includes various entities and components introduced above with reference to the environment 100.

Generally, based on a multimodal recognition of user state, identity, and context, a combined display/speech interaction system selectively adapts the system behavior to improve accessibility, time needed for data retrieval, and convenience. Various adaptations may be implemented via the system behavior manager 130 that operates in connection with the digital assistant 126 as noted previously. For example, the scenario 200 includes the system behavior manager 130 in this case implemented as a component of a digital assistant 126. In operation, the system behavior manager 130 obtains sensor data 202 that may be collected via various sensors 132. The sensor data 202 is analyzed and interpreted by the system behavior manager 130 to determine contextual factors such as user presence, identity, proximity, emotional state, and other factors noted above and below. System behavior adaptations 204 are defined and mapped to different contextual factors and combinations of the contextual factors. System behavior adaptations 204 that correspond to the current context are identified and applied to adapt the user experience 206 accordingly. Generally, the user experience 206 includes different attributes of a digital assistant experience such as audible experience, visual experience, touch-based experience, and combinations thereof Various types of adaptations of user experience are contemplated, details of which are described above and below.

Context Retrieval and Input Sensing

In order to perform input sensing, a number of different interaction modalities can be employed to the obtain, process and interpret contextual information via various sensors.

Presence sensing: The physical presence of people (i.e. people nearby the system) may be detected using sensors 132 like pyro-electric infrared sensors, passive infrared (PIR) sensors, microwave radar, microphones or cameras, and using techniques such as Doppler radar, radar using time-of-flight sensing, angle-of-arrival sensing inferred from one or more of Doppler radar or time-of-flight sensing, and so forth. While the inferences from PIR sensors may be binary (presence/no presence), modalities like radar can provide more fine-grained information, that can include a positioning element (e.g. x/y/z position relative to the PC), an element indicative of distance to the person (e.g. magnitude of the returned signal), or an element that allows for inferences of certain situations like approaching the system. Another technique to recognize presence involves using position of a user's other devices, such as detecting that a user's smartphone or tablet device is connected within a home network.

Sound: In order to enable interaction with the computer using a speech-based interface, one or multiple microphones representing instances of the sensors 132 can be employed. Using multiple microphones enables the use of sophisticated beamforming techniques to raise the quality of speech recognition and thus the overall interaction experience. Further, when motion information (e.g., angle of arrival information) is available (e.g., from radar information), a beamforming estimate can be used to enhance speech recognition, such as before any speech input is detected.

Also, the system (e.g., the client device 102) can disambiguate between multiple sound sources, such as by filtering out the position of a known noise-producing device (e.g., a television) or background noise. When the identity of a user is known (such as discussed below), it is possible to apply a different speech recognition model that actually fits the user's accent, language, acoustic speech frequencies, and demographic.

Position: As noted above, radar or camera-based sensors 132 may provide a position for one or multiple users. The position is then used to infer context, e.g. approaching the client device 102, moving away from the client device 102, presence in a different room than the client device 102, and so forth. Also, the system can recognize whether a person just passes by or has the intention to actually interact with the device itself Based on the position of a person, beamforming parameters for speech recognition may also be adapted, which is discussed in be detailed below. Distance and/or proximity can also be detected using ultrasonic detection, time-of-flight, radar, and/or other techniques.

Identity Recognition: Identity recognition can employ camera-based face recognition or more coarse-grained recognition techniques that approximate the identity of a user. The system may also recognize the locations or movements of other devices which may be personal devices, and use this to determine identity. This may be done with or without cooperating software components on those devices. For example, accelerometer events detected by a smartphone may be correlated with movements sensed for a particular user, allowing the system to infer that, with some probability, the moving user's identity is that of the smartphone owner. In another example, the radio signals (e.g. WiFi signals) from a smartphone may be localized and this location may be correlated to a user to (probabilistically) identify the user.

Emotional State/Situational Intelligence: Similar to the previous camera-based identity recognition, estimating an emotional state is another factor that may be employed to adapt output parameters. The emotional state can be derived based on presence sensors (e.g. radar) to infer a situation in which potentially stress could be introduced, e.g. when there is lots of movement in the morning before leaving. On the other hand, using more fine-grained camera-based sensors allows to recognize a detailed emotional state (e.g. happy, sad, stressed, and so on) that can be used to adapt the system behavior even further. Thermographic imaging can also be used to infer emotional state, as can biometric sensors such as pulse rate, breathing rate, and so on. Voice analysis can also lead to inference of emotional state, e.g., stress level.

Typically, users have multiple devices in one's home. This enables the system to implement multiple device scenarios. Adaptation may accordingly include determine which device to use to obtain input, provide visualization and alters, deliver response and so forth. For instance, a response can be output via a user's mobile phone screen when the system knows a user in a different room, whereas the same response may be delivered via to the main display device when the user is present. Additionally, information regarding user interaction and behavior can be fused from multiple systems into one common model. This has the advantage of aggregating knowledge and thus be able to personalize and target the user experience even better.

Output and Actuation

The output, or more general actuation, is mainly based on two interaction modalities: sound and display. However, these two modalities are tightly interwoven with each other based on the contextual data retrieved by sensors 132 and prior knowledge about the user's habits and situation.

Switching system behavior between multiple output modalities can be illustrated by the following example situations. Adaptations of the system behavior are designed to making information easily accessible in various interaction scenarios and contexts.

Adapting to the position: When the contextual information indicates that a person who would like to interact with the system is not able to see the screen, the system behavior manager 130 may be configured to switch to sound output in preference over displaying data visually. The same is true for situations in which a person interacts from farther away. Depending on the distance, the system may operate to switch to sound, use sound and visual UIs, and/or adapt visual UI for distance by changing font size, graphics, colors, level of detail, contrasts and other aspects used for visualization. When the person is further away from the system, the system may also adjust the volume of sound output or the clarity of speech synthetization by increasing the overall pitch. As the person approaches the system, indications such as icons, animations, and/or audible alerts may be output to signal that different types of interaction are active and also indications may be output to indicate when the user identity has been recognized, e.g., via an alert sound and showing of user icon.

Adapting to presence: When no presence is detected, the system may switch to low-power mode, and then rely on designated sensors that remain active to detect presence. Generally, an active, “always-on” sensor or sensors provide simple presence detection and consume relatively little power. Other sensors will be switched off and then switched back on in response to presence detection by the always-on sensors. Thus, presence is first detected and the system is activated. Then, additional sensors are invoked to detect position, distance, identity, and other characteristics that enable further context-based adaptations of the system behavior. Based on presence sensing, display brightness may be adjusted, such as to a low output level when a user is detected at a far distance before switching off the screen completely.

Adapting to the user's identity: When one or multiple users interact with the system, the system tailors the content based on the user's preferences. For example, when asking the digital assistant 126 for the calendar, the system automatically composes information of one or more people and merges possible appointments in a multi-user interaction scenario. The digital assistant 126 may also be configured to find the next free appointment for multiple parties. Related to user identity are also different needs for accessibility, for example when a user has different preferences, is in a different age group, or has a disability. The system is configured to adapt system behavior accordingly such as changing the voice settings in terms of language, pitch, vocabulary, switching language models, and changing the visualization. System behavior may also be adapted by selecting a different output modality, such as to support people with limited eyesight, limited hearing, or use age appropriate user interfaces and vocabulary.

Adapting to the user's emotional state: A camera recognition system and/or other sensor can recognize affective states like happiness, sadness, or stress, and state of the art radar systems can measure respiration and heart rate. This knowledge from the context can be included as a factor used to select interaction modality (e.g., for input and output), and otherwise adapt the system behavior. For example, if a user is recognized as being stressed, the digital assistant 126 may opt to keep answers to questions shorter than usual to simulate human intelligence. In another example, if the system recognizes excitement and activity, like a social gathering, the digital assistant 126 may opt not to interrupt the user. Similarly, UI visualizations and available options presented via the digital assistant 126 may also be adapted to correspond to a recognized emotional state.

In addition to a system's primary audio and visual interfaces, output may additionally or alternatively comprise other modalities, which may be through other devices. These devices may include home automation appliances or robots. For example, if a user Alice requested through voice that a robot vacuum clean a specific spot on the carpet, and the system determined that the robot vacuum cleaner was audible or visible by Alice at the current time, then it may choose to minimize or forego using audio or video on its primary interfaces to respond, but instead cause the robot vacuum to give indications that the action is underway: audibly, visibly, or simply through its actions. In another example, if Alice requested that a song being played in the room she is in be changed, then the response may minimize or forego audio or visual activity of the primary interfaces, but instead simply change the song, which by itself provides the feedback that the action was accomplished.

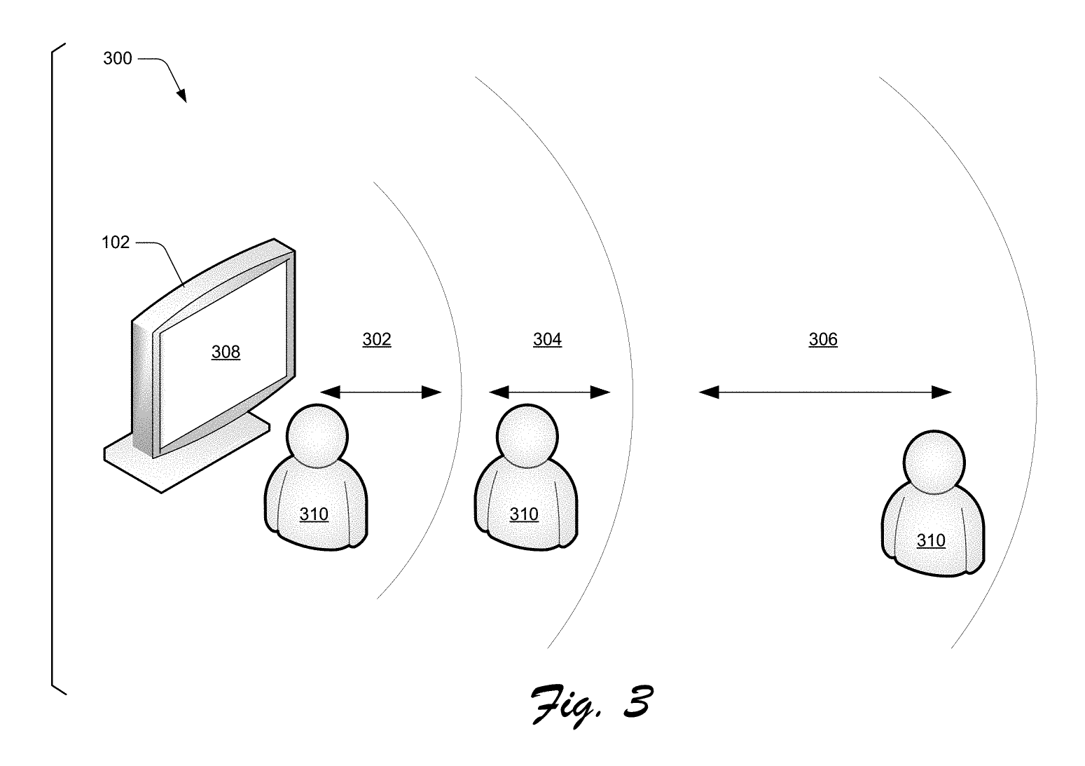

FIG. 3 depicts an example scenario 300 which represents different proximity based interaction modalities that may be implemented in accordance with techniques described herein. In particular, the scenario 300 shows different proximity zones at different distances from a reference point (e.g., 2′, 3′, 10′) that correspond to different interaction modalities. Generally, the different proximity zones represent different ranges of distances from a reference point, which in this example is the client device 102. In this particular example, the scenario 300 includes a first proximity zone 302, a second proximity zone 304, and a third proximity zone 306.

At close proximity in the first proximity zone 302 (e.g., a within a 2 foot arc from the client device 102), touchable interactions are available since a user is close enough to touch a display 308 of the client device 102, use input devices of the client device 102, and so forth. Accordingly, the digital assistant 126 may make adaptations to a user interface displayed on the display 308 to support touch and other close proximity interactions. Generally, the display 308 can be implemented in various ways, such as a 2-dimensional (2D) display, a 3-dimensional (3D) display, and so forth. Also, the display 308 may be implemented as other than a typical rectangular display, such as a single light-emitting diode (LED) which can be controlled to indicate a status, an LED strip, a character-based display, and so forth.

Farther away within the proximity zone 304 (e.g., between a 2 foot and a 3 foot arc from the client device 102), visual interactions are available since the digital assistant 126 determines that a user is likely close enough to be able to see the display 308 clearly. In this case, the digital assistant 126 may make adaptations to accommodate visual interactions and delivery of information visually. Speech may be used in this range also since the user is determined to be not close enough for touch. Still further away in the proximity zone 306 (e.g., between a 3 foot and a 10 foot arc from the client device 102), speech interactions are available since the digital assistant 126 determines that the user is determined to be too far from the display 308 for other modes like touch and visual interaction. In the proximity zone 306, for instance, the digital assistant 126 determines that a user is likely not be able to see the display clearly. Here, the digital assistant 126 may make adaptations to provide audio-based interactions and commands, and/or modify UI to accommodate the distance by using large elements, increasing text size, and reducing details so the information is easier to digest from a distance.

Consider, for instance, that a user 310 (“Alice”) enters a living area of her house in which the client device 102 is situated. The system behavior manager 130 or comparable functionality senses her presence in the proximity zone 306 via various sensors 132. In response, the client device 102 is transitioned from a low power mode to an active mode. Further, the digital assistant 126 is put in an active state and a visualization such as an icon or graphic associated with the digital assistant 126 is exposed to indicate availability for speech interaction and other input. The digital assistant 126 is now ready for user interaction. While Alice detected to be present in the proximity zone 306, the digital assistant 126 provides an interactive user experience that is appropriate to a distance associated with the proximity zone 306. For instance, the digital assistant 126 outputs an audio prompt to Alice that informs Alice of an event that is pending (e.g., an upcoming calendar event), that notifies Alice of available actions (e.g., that certain news stories are available), that inquires as to whether Alice needs assistance with a task, and so forth.

In at least some implementations, a volume of the audio prompt is adjusted based on Alice's distance from the client device 102. For instance, when Alice first enters the proximity zone 306 and is initially detected, an audio prompt may be relatively loud. However, as Alice continues toward the client device 102 an approaches the proximity zone 304, volume of an audio prompt may be reduced.

While Alice is present in the proximity zone 306, the digital assistant 126 may also provide visual output that is tailored to an associated viewing distance from the display 308. For instance, very large characters can be displayed that provide simple messages and/or prompts, such as “Hello!,” “May I Help You?,” and so forth.

Now, Alice walks closer to the client device 102 and transitions from the proximity zone 306 to the proximity zone 304. Accordingly, the system behavior manager 130 senses her approach and identifies her via the sensors 132. Based on this, the digital assistant 126 exposes more information and/or identity specific information since she is nearer and has been identified/authenticated. For instance, based on one or more biometric techniques, Alice is identified and authenticated as being associated with a particular user profile. Examples of such biometric techniques include facial recognition, voice recognition, gait recognition, and so forth. Additional information output for Alice may include her work calendar, additional cues to interact with the speech based system, examples of things to say, reminders, message indictors and previews, and so forth. In the proximity zone 304, the digital assistant 126 can provide a mix of audio and visual output since the proximity zone 304 is determined to be within an acceptable viewing distance of the display 308. In other words, the system behavior manager 130 adapts the system behavior based on proximity and identity of the user by making adaptations to the user experience and visualization shown in different scenarios.

While Alice is in the proximity zone 304, the digital assistant 126 can adapt UI features based on a viewing distance associated with the proximity zone 304. For instance, an appropriate font size for characters output by the display 308 can be selected based on a known range of viewing distances within the proximity zone 304. In a scenario where the digital assistant 126 provides visual output while Alice is in the proximity zone 306, font size and/or output size of various visuals can be decreased as Alice transitions from the proximity zone 306 to the proximity zone 304. This provides for more comprehensive utilization of screen space afforded by the display 308 such that richer information sets can be output for Alice's consumption.

In an example scenario, Alice may ask about a scheduled soccer game while in the proximity zone 306 and receive a voice response because the digital assistant 126 knows Alice's proximity and determines voice is appropriate in the proximity zone 306. As she walks closer and enters the proximity zone 304, the digital assistant 126 recognizes the approach (e.g., change in proximity) and adapts the experience accordingly. For example, when Alice enters the proximity zone 304, the digital assistant 126 may automatically display a map of the soccer game location on the display 308 in response to detection of her approach via the system behavior manager 130.

Now assume Alice's husband Bob walks into the room and enters the proximity zone 306 while Alice is still present in the proximity zone 304. The system behavior manager 130 recognizes that two people present in the room. Consequently, the user experience is adapted for multi-user interaction. For example, the digital assistant 126 may remove Alice's work calendar, hide any private information, and focus on appropriate multi-user aspects, such as whole-household events, shared family collections, and so forth. Further, while Bob is in the proximity zone 306 and Alice is in the proximity zone 304, the volume of audio output by the digital assistant 126 can be adjusted to account for multiple people at multiple different distances from the client device 102. For instance, the volume may be increased to enable Bob to hear the audio while present in the proximity zone 306.

In one particular implementation, the increase in volume to account for Bob's presence can be tempered to account for Alice's proximity to the client device 102. For example, instead of simply increasing a volume of audio output to a level specified for users present only in the proximity zone 306, a different (e.g., less loud) volume increase can be implemented based on mixed proximity of Alice and Bob. This avoids presenting a diminished user experience to Alice that may occur if audio output is excessively loud for her proximity

Alternatively or additionally, if the system has access to multiple speakers, different speakers can be chosen for output to Bob and Alice, and respective volume levels at the different speakers can be optimized for Bob and Alice.

The system behavior manager 130 may also recognize or be aware that Bob has a visual impairment. Consequently, when the system has identified Bob it may cause the digital assistant 126 to use speech interfaces along with visual information or switch entirely to speech interfaces.

Consider that Alice approaches the client device 102 and enters the proximity zone 302. The digital assistant 126 detects that Alice enters the proximity zone 302 (e.g., based on a notification from the system behavior manager 130), and adjusts its user experience accordingly. The proximity zone 302, for instance, represents a distance at which Alice is close enough to touch the display 308. Accordingly, the digital assistant 126 presents touch interaction elements in addition to other visual and/or audio elements. Thus, Alice can interact with the digital assistant 126 via touch input to touch elements displayed on the display 308, as well as other types of input such as audio input, touchless gesture input (such as detected via the light sensors 132b), input via peripheral input devices (e.g., a keyboard, mouse, and so forth), and so on. In at least some implementations, the digital assistant 126 does not present touch interaction elements until a user (in this case, Alice) is within the proximity zone 302. For instance, touch elements are not presented when Alice is in the other proximity zones 304, 306 since these zones are associated with a distance at which the display 308 is not physically touchable by Alice.

Alternatively or additionally, when Alice is in the proximity zones 304, 306, the digital assistant 126 can present touchless input elements on the display 308 that are capable of receiving user interaction from Alice via touches gestures recognized by the light sensors 132b.

Further to the scenario 300, when Alice leaves the room and is not detected in any of the proximity zones, the system behavior manager 130 detects this and cause the system to enter a low-power mode where speech interaction is not available and the digital assistant 126 may be in a suspended state. One or more sensors 132, however, may remain active in the low-power mode to detect the next event and cause the system to respond accordingly. For example, a presence sensor may continue to monitor for user presence and trigger a return to an active state when presence of a user is again detected in one of the proximity zones 302-306. Alternatively, the system may be responsive to events indicative of user presence which are detected by remote devices, by being in a “connected standby” state where network activity is still possible. For example, if Alice's phone detects that she has returned home, it may trigger the home PC to wake up.

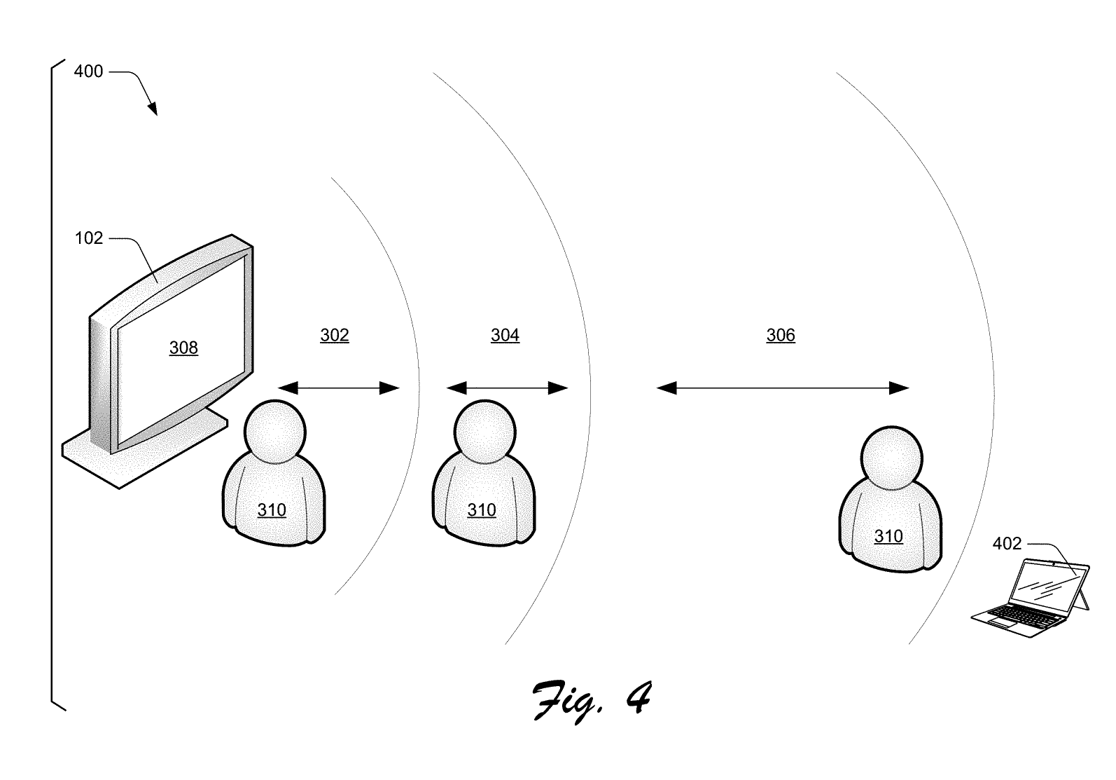

FIG. 4 depicts an example scenario 400 for transfer of user experience between devices in accordance with techniques described herein. The scenario 400, for instance, represents a variation and/or extension of the scenario 300. Consider, for example, that the user 310 (Alice) moves away from the client device 102 through the proximity zones 302, 304 until she reaches the proximity zone 306. Consider further that the system (e.g., via the system behavior manager 130) determines that a different client device (“different device”) 402 is present within and/or nearby to the proximity zone 306. In at least some implementations, the different device 402 represents a different instance of the client device 102.

Generally, the system may ascertain the location of the different device 402 in various ways. For instance, the client device 102 may directly detect the presence and location of the different device 402, such as via a wireless beacon or other signal transmitted by the different device 402 and detected by the client device 102. In another example, the digital assistant service 140 can notify Alice's various devices of locations and identities of the different devices. The digital assistant service 140, for instance, can notify the client device 102 of the presence and location of the different device 402, and may also notify the different device 402 of the presence and location of the client device 102. In yet another example, the different device 402 detects Alice's proximity and notifies the client device 102 that Alice is close enough to the different device 402 that the different device 402 may begin providing a user experience to Alice. Thus, using this knowledge, the client device 102 and the different device 402 can cooperate to provide a seamless user experience to Alice.

Continuing with the scenario 400 and responsive to Alice moving from the proximity zone 304 to the proximity zone 306, the digital assistant 126 causes a user experience to be transitioned from the client device 102 to the different device 402. Consider, for example, that Alice was reading and/or listening to a news story on the client device 102. Accordingly, the digital assistant 126 causes the news story to transition from being output by the client device 102, to being output by the different device 402. In at least some implementations, the client device 102 and the different device 402 may temporarily overlap in providing an identical user experience to Alice to prevent Alice from missing a certain portion of the user experience, such as a certain portion of the news story. However, once Alice reaches a certain proximity to the different device 402, the client device 102 may stop presenting the user experience, and the different device 402 may continue presenting the user experience. Thus, techniques for digital assistant experience based on presence sensing described herein can provide a portable user experience that can follow a user from device to device as the user moves between different locations.

In at least some implementations, such as in the scenarios described herein, different instances of the sensors 132 can trigger each other based on sensed phenomena, such as in a cascade. For instance, a motion sensor (e.g., an infrared sensor) can detect user motion and trigger a camera-based sensor to wake and capture image data, such as to identify a user. As a user moves between different proximity zones, for example, sensors may communicate with one another to wake and/or hibernate each other depending on user proximity and position. This saves energy by enabling various sensors to be hibernated and woken by other sensors, and also may enhance privacy protection.

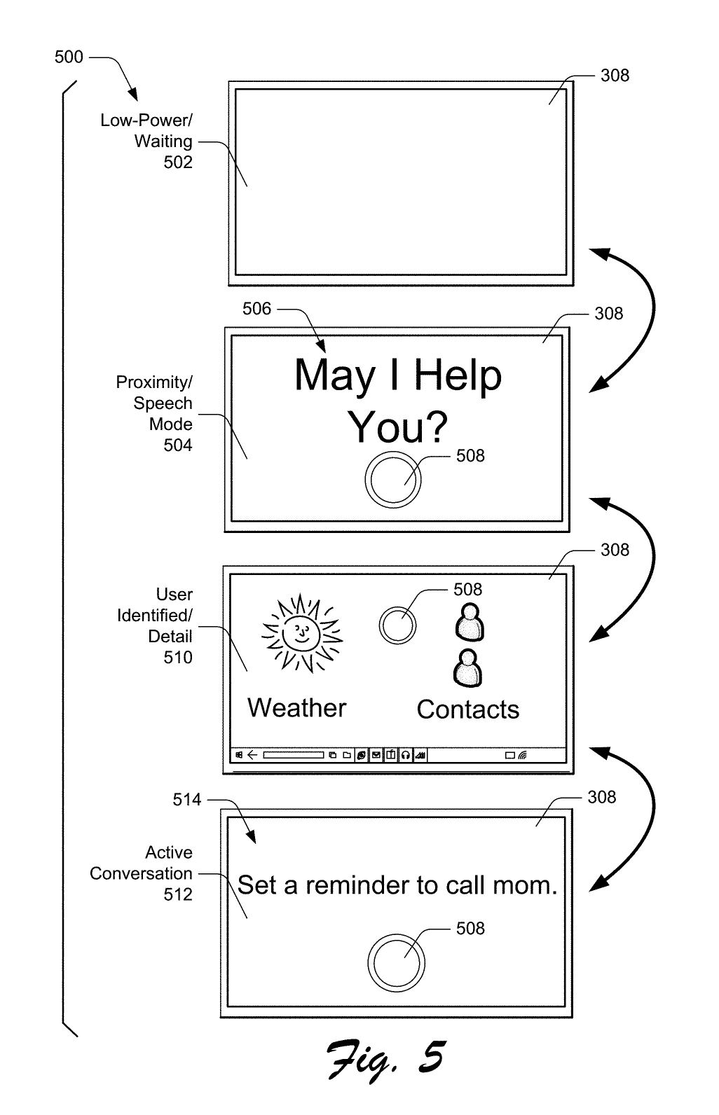

FIG. 5 depicts an example scenario 500 for adapting a user interface for user experience in accordance with techniques described herein. The scenario 500, for instance, depicts different implementations of a user interface that can be presented and adapted based on user proximity, such as described in the example scenarios above. For example, the described user interfaces for the digital assistant 126 may be provided in dependence upon contextual factors in accordance with one or more implementations. The digital assistant 126, for instance, may switch back and forth between different user interfaces in accordance with system behavior adaptations that are derived via the system behavior manager using sensor data 202 collected from sensors 132.

The example user interfaces depicted in the scenario 500 include a low-power/waiting interface 502 in which the display 308 is off or in in a very dim mode. The interface 502, for instance, is output in the absence of user presence or otherwise when the system enters the low-power mode and waits for the next action. For instance, when a user is not detected in any of the proximity zones 302, 304, 306, the interface 502 is presented.

A proximity/speech mode interface 504 may be presented when the system is initially activated when presence is detected and/or for audio-based interaction from a particular distance away from a reference point, e.g. in the proximity zone 306 and beyond. The interface 504 may include information that is appropriate while the system attempts to gather additional context via sensors and/or when audio-based modalities are dictated based on the context. In this particular example, the interface 504 includes an assistance query 506 and a digital assistant visual 508. Generally, the assistance query 506 represents a query that asks whether a user wants help with a certain tasks. In at least some implementations, an audio query may be output additionally or alternatively to the visual representation of the assistance query 506. According to various implementations, the assistance query 506 is not directed to a particular user, but is presented for general use by any user. For instance, a user that is detected in the proximity zone 306 may not be identified and/or authenticated, and thus the assistance query 506 is presented as a general query that is not specific to any particular user identity such that any user may respond and receive assistance from the digital assistant 126. Generally, a user may respond to the assistance query 506 in various ways, such as via voice input, touchless gesture input, and so forth. The digital assistant visual 508 represents a visual cue that the digital assistant 126 is active and available to perform a task.

A user identified/detail interface 510 represents an expanded visualization that may be provide when the user moves closer to the client device 102 and/or is identified. For instance, the interface 510 can be presented when a user moves from the proximity zone 306 to the proximity zone 304 and is identified and/or authenticated as a particular user. The interface 510 may include various interaction options, customized elements, user-specific information, and so forth. Such details are appropriate when the system detects that the user is more engaged by moving closer, providing input, and so forth. Notice further that digital assistant visual 508 continues to be presented with the transition from the interface 504 to the interface 510.

The scenario 500 further depicts an active conversation interface 512, which may be output during an ongoing conversation between a user and the digital assistant. Here, the system provides indications and feedback with respect to the conversation, such as by displaying recognized speech 514, providing suggestions, and/or indicating available voice command options. The interface 512 may be presented when the user is close enough to clearly view the display and benefit from additional visual information provided during the active conversation, such as within the proximity zones 302, 304. Notice further that digital assistant visual 508 continues to be presented with the transition from the interface 510 to the interface 512, providing a visual cue that the digital assistant 126 is still active.

If the user moves farther away, such as to the proximity zone 306, the system may transition from using the interface 512 to one of the other interfaces 510, 504, since these interfaces may provide interaction modalities that are better suited to interaction from a longer distance.

In general, the system is able to transition between different UIs and adapt the UIs dynamically during an ongoing interaction based on changing circumstances. For example, different UI and modalities in response to changes in user proximity, number of users present, user characteristics and ages, availability of secondary device/displays, lighting conditions, user activity, and so forth. For example, the level or interaction available and detail of the corresponding UIs can be ramped-up and back down based on the user proximity and whether the user identity is detected. Additionally, the system can recognize secondary displays and devices and select which device to use for given interaction based on the available devices, device types, and context.

For example, a requested recipe can be cast from a living room device to a tablet in the user's kitchen based on recognition that user is moving towards or in the kitchen. The system can also activate and deactivate public/private information based on the number of user present and who the users are. Volume adjustments may also be made based on proximity and/or ambient noise levels. In another example, the system may recognize when to be less disruptive based on factor such as the time of day, activity of users, ambient light level and other indicator that a user is busy or would benefit from less intrusive interaction. In this scenario, the system may choose to use displays with minimal information, lower brightness, discrete audio cues, and so forth.

According to various implementations, the transitions between different user experience modalities discussed in the scenarios above and elsewhere herein can occur automatically and responsive to detection of user movement and proximity, and without direct user input instructing the system to shift modality. For instance, based solely on proximity information detect by the sensors 132 and/or proximity information from a different source, the system behavior manager 130 can instruct the digital assistant 126 to perform and adapt different aspects of the digital assistant experience as described herein.

Having described some example implementation scenarios, consider now some example procedures in accordance with one or more implementations.

Example Procedures

In the context of the foregoing example scenarios, consider now some example procedures for digital assistant experience based on presence sensing in accordance with one or more implementations. The example procedures may be employed in the environment 100 of FIG. 1, the system 900 of FIG. 9, and/or any other suitable environment. The procedures, for instance, represent ways for implementing the example implementation scenarios discussed above. In at least some implementations, the steps described for the various procedures can be implemented automatically and independent of user interaction. The procedures may be performed locally at the client device 102, by the digital assistant service 140, and/or via interaction between these functionalities. This is not intended to be limiting, however, and aspects of the methods may be performed by any suitable entity.

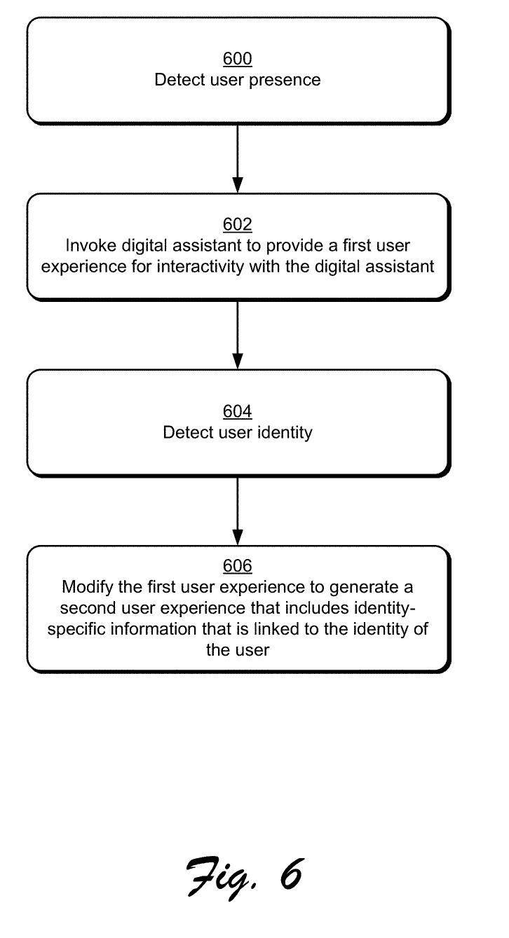

FIG. 6 is a flow diagram that describes steps in a method in accordance with one or more implementations. The method describes an example procedure for modifying a user experience based on user identity in accordance with one or more implementations.

Presence of a user is detected (block 600). The system behavior manager 130, for instance, detects a user's presence, such as based on data from one or more of the sensors 132. For example, the user is detected in one of the proximity zones 302, 304, 306.

A digital assistant is invoked to provide a first user experience for interactivity with the digital assistant (block 602). For example, the system behavior manager 130 instructs the digital assistant 126 to provide an interaction modality that indicates to the user that the digital assistant 126 is active and available to receive speech input and perform various tasks. In at least some implementations, this is based on the user's presence in the proximity zone 306 and/or the proximity zone 304. In one particular example, the first user experience includes an assistance query without identity-specific information that is linked to an identity of the user.

Identity of a user is detected (block 604). The user, for example, moves to a proximity to the client device 102 where a user-specific attribute is detected by one or more of the sensors 132, and used to identify and/or authenticate the user. Different ways of detecting user identity are discussed above, and include various biometric features and techniques.

The first user experience is modified to generate a second user experience that includes identity-specific information that is linked to the identity of the user (block 608). For instance, user-specific information such as calendar, contacts, preferred content, and so forth, is presented by the digital assistant 126 to the user.

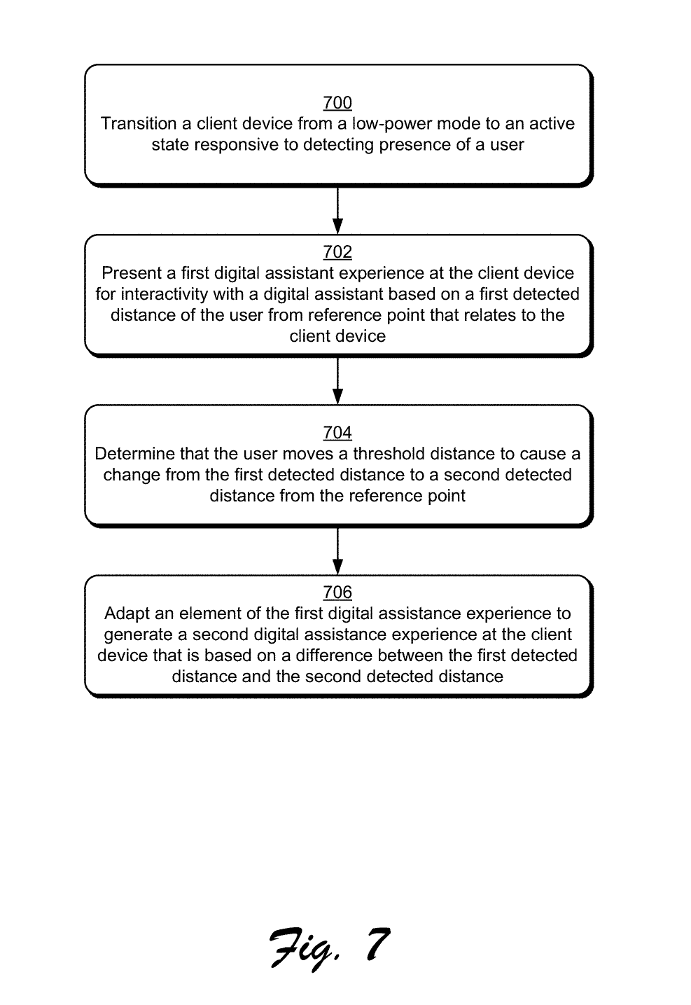

FIG. 7 is a flow diagram that describes steps in a method in accordance with one or more implementations. The method describes an example procedure for adapting a digital assistant experience based on sensor data in accordance with one or more implementations.

A client device is transitioned from a low-power mode to an active state responsive to detecting presence of a user (block 700). The system behavior manager 130, for instance, receives sensor data from a sensor 132, and instructs the operating system to transition from the low power mode to the active state. As mentioned above, the sensors 132 and/or the system behavior manager 130 may be implemented by a separate subsystem that is partially or fully independent of the primary processing system 104. Thus, in such implementations, the system behavior manager 130 subsystem can signal the processing system 104 to wake and execute the operating system 108. In the low power mode, for instance, various resources of the client device 102 such as the processing system 104 and the display device 308 are hibernated and/or powered off. Accordingly, transitioning to the active state causes these device resources to be awakened.

A first digital assistant experience is presented at the client device for interactivity with a digital assistant based on a first detected distance of the user from reference point that relates to the client device (block 702). For example, the system behavior manager 130 invokes the digital assistant 126 and instructs the digital assistant 126 to present a digital assistant experience based on one or more contextual factors that apply to the first detected distance. Different contextual factors are detailed throughout this discussion, and include information such as distance (e.g., physical distance of a user, estimated viewing distance of a user, and so on), identity, emotional state, interaction history with the digital assistant, and so forth.

In at least some implementations, the first digital assistant experience emphasizes a particular interaction modality, such as audio-based interaction. For instance, at the first detected distance, the system behavior manager 130 determines that audio is a preferred interaction modality, and thus instructs the digital assistant 126 to emphasize audio interaction (e.g., output and input) in presenting the first user experience. While the first user experience may emphasize audio interaction, visual interactivity may also be supported. The digital assistant 126, for instance, may provide visual output that is configured for viewing at the first detected distance. For instance, with reference to the scenarios 200, 300, the digital assistant 126 can output text and/or other visual elements at a size that is configured to be readable from the proximity zone 306.

Generally, the reference point may be implemented and/or defined in various ways, such as based on a position of one or more of the sensors 132, a position of the display 308, a position of some other pre-defined landmark, and so forth.

A determination is made that the user moves a threshold distance to cause a change from the first detected distance to a second detected distance from the reference point (block 704). The threshold distance, for instance, is measured in relation to the reference point and may be defined in various ways, such as in feet, meters, and so forth. Examples of a threshold distance include 1 foot, 3 feet, 5 feet, and so forth. As detailed above, different proximity zones can be defined that are associated with different user experiences and/or interactivity modalities. Thus, a determination that a user moves a threshold distance can include a determination that the user moves from one proximity zone to a different proximity zone.

In at least some implementations, a reference point (e.g., the display 308) can be occluded at different distances, such as depending on an angle of approach of a user relative to the reference point. In such as case, a particular sensor (e.g., a camera) can resolve this occlusion, even when another sensor (e.g., radar) may not be able to resolve the occlusion.

An element of the first digital assistant experience is adapted to generate a second digital assistant experience at the client device that is based on a difference between the first detected distance and the second detected distance (block 706). As detailed throughout this discussion, different distances from a reference point (e.g., the client device 102) can be associated with different emphasized interaction modalities. For instance, with reference to the proximity zones detailed above, different user experiences and/or interactivity modalities can be emphasized in different proximity zones. Thus, different elements such as an audio element and/or a visual element can be adapted in response to user movement.

Consider, for example, that as part of the first user experience, the digital assistant provides audio output at a volume that is considered audible at the first detected distance. When the user moves the threshold distance to the second detected distance, the volume can be adjusted to a level that is suitable for the second detected distance. For instance, if the second detected distance is closer to the reference point than the first detected distance, the volume of the audio output can be reduced to avoid user annoyance or discomfort due to excessive audio volume.

Consider another example where visual output such as text is provided as part of the first user experience. The visual output may be sized so as to be visually discernable at the first detected distance. For example, a font size of text may be configured such that the text is readable at the first detected distance. When the user moves the threshold distance to the second detected distance, the visual output may be resized to a size that is considered visually discernable at the second detected distance. For instance, if the second detected distance is closer to the reference point than the first detected distance, the size of the visual output may be reduced, such as to allow for additional visual elements to be presented.

While these examples are discussed with reference to a move from a farther detected distance to a nearer detected distance, an opposite adaption may occur when a user moves from a closer detected distance to a farther detected distance. Further, other interaction modalities may be utilized, such as gesture-based input, touch input, tactile output, and so forth.

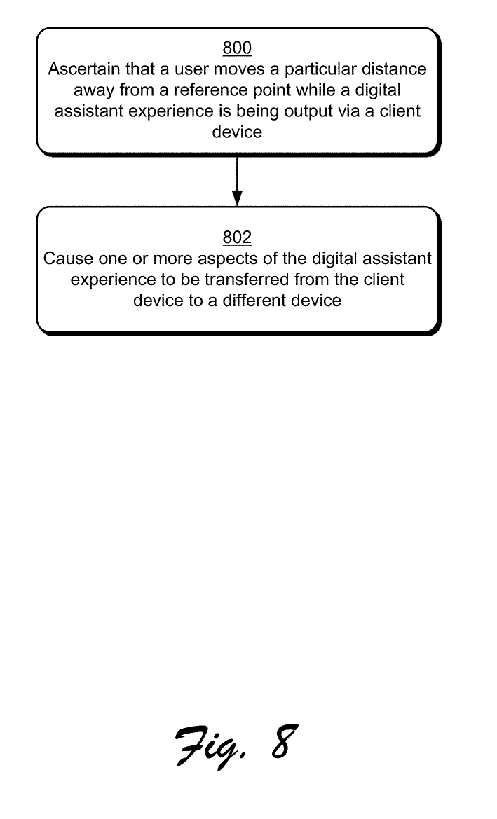

FIG. 8 is a flow diagram that describes steps in a method in accordance with one or more implementations. The method describes an example procedure for transferring an aspect of a digital assistant experience between devices in accordance with one or more implementations. The method, for example, represents an extension of the methods described above.

It is ascertained that a user moves a particular distance away from a reference point while a digital assistant experience is being output via a client device (block 800). The system behavior manager 130, for example, determines that while the digital assistant 126 is presenting a user with a digital assistant experience at the client device 102, the user moves a particular, pre-defined distance away from the client device 102 and/or the display device 308. Generally, the particular distance may be defined in various ways, such as with reference to the proximity zones discussed above. The particular distance, for example, may indicate that the user has moved into and/or beyond the proximity zone 306.

One or more aspects of the digital assistant experience are caused to be transferred from the client device to a different device (block 802). The system behavior manager 130, for example, initiates a procedure to cause aspects of the second digital assistant experience to be initiated and/or resumed at the different device. Generally, the different device may correspond to a device that is determined to be closer to a current location of the user than the client device 102. In at least some implementations, transferring an element of the digital assistant experience causes the digital assistant experience to be initiated at the different device and content included as part of the experience to be output at the different device.

Transferring elements of a digital assistant experience to a different device may be performed in various ways. For instance, in an example where a user is engaged in a conversation with the digital assistant 126, the conversation may be continued at the different device. As another example, where content is being output as part of the digital assistant experience, the content can resume output at the different device. For example, if the digital assistant experience includes a content stream such as a news program, the content stream can be output at the different device. Thus, a digital assistant experience can be transferred between devices to enable a user to remain engaged with the experience as the user moves between different locations.

In at least some implementations, transferring elements of a digital assistant experience can be implemented via the digital assistant service 140. For instance, the digital assistant 126 can communicate state information for the digital assistant experience to the digital assistant service 140, which can then communicate the state information to the different device to enable the different device to configure its output of the digital assistant experience. Alternatively or additionally, transferring elements of a digital assistant experience can be implemented via direct device-device communication, such as between the client device 102 and the different device 402 discussed with reference to the scenario 400.

Thus, techniques for digital assistant experience based on presence sensing discussed herein provide for adaptable digital assistant experiences that consider various contextual factors such as user proximity, user identity, user emotional state, and so forth. Further, the techniques enable system resources to be conserved by enabling the resources to be powered off and/or hibernated when the resources are not used for a particular interaction modality for a digital assistant experience.

Having considered the foregoing procedures, consider a discussion of an example system in accordance with one or more implementations.

Example System and Device

FIG. 9 illustrates an example system generally at 900 that includes an example computing device 902 that is representative of one or more computing systems and/or devices that may implement various techniques described herein. For example, the client device 102 and/or the digital assistant service 140 discussed above with reference to FIG. 1 can be embodied as the computing device 902. As depicted, the computing device 902 may implement one or more of the digital assistant 126, the system behavior manager 130, the sensors 132, and/or the digital assistant service 140. The computing device 902 may be, for example, a server of a service provider, a device associated with the client (e.g., a client device), an on-chip system, and/or any other suitable computing device or computing system.

The example computing device 902 as illustrated includes a processing system 904, one or more computer-readable media 906, and one or more Input/Output (I/O) Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 910 and computer-readable media 906 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules that are executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a wearable device, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. For example, functionalities discussed with reference to the client device 102 and/or the digital assistant service 112 may be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device implementation, implementation of functionality described herein may be distributed throughout the system 900. For example, the functionality may be implemented in part on the computing device 902 as well as via the platform 922 that abstracts the functionality of the cloud 920.

Discussed herein are a number of methods that may be implemented to perform techniques discussed herein. Aspects of the methods may be implemented in hardware, firmware, or software, or a combination thereof The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for adapting a digital assistant experience, the system comprising: a processing system; and computer readable media storing instructions that are executable by the processing system to cause the system to perform operations including: presenting, at a client device, a first digital assistant experience for interactivity with a digital assistant based on a first detected distance of a user from a reference point that relates to the client device; determining that the user moves a threshold distance to cause a change from the first detected distance to a second detected distance from the reference point; and adapting an element of the first digital assistant experience to generate a second digital assistant experience at the client device that is based on a change in a contextual factor that results from the user moving from the first detected distance to the second detected distance from the reference point.

In addition to any of the above described systems, any one or combination of: wherein the operations further include, prior to said presenting the first digital assistant experience, causing the client device to transition from a low-power mode to an active state responsive to detecting presence of the user; wherein the reference point comprises one or more of the client device or a display device of the client device; wherein the first detected distance is greater than the second detected distance, and the contextual factor comprises an estimated viewing distance of the user from a display device of the client device; wherein the first detected distance is greater than the second detected distance, the contextual factor comprises an estimated viewing distance of the user from a display device of the client device, and the element of the first digital assistant experience comprises an interaction modality for interacting with the digital assistant; wherein the first detected distance is greater than the second detected distance, the contextual factor comprises an estimated viewing distance of the user from a display device of the client device, and wherein adapting the element of the first digital assistant experience comprises increasing a font size of the element; wherein the contextual factor comprises an indication of whether an identity of the user is known; wherein said adapting further comprises adapting the element of the first digital assistant experience based on an indication regarding the user's emotional state; wherein the element of the first digital assistant experience comprises an input mode of the digital assistant, and said adapting comprises switching between an audio interaction mode and a visual interaction mode for interaction with the digital assistant; wherein the element of the first digital assistant experience comprises a visual user interface of the digital assistant, and said adapting comprises adapting an aspect of the visual user interface including one or more of changing a font size, a graphic, a color, or a contrast of the visual user interface in dependence upon the change in the contextual factor; wherein the operations further include: ascertaining that the user moves a particular distance away from the reference point; and causing, responsive to said ascertaining, one or more aspects of the second digital assistant experience to be transferred to a different device.

A method implemented by a computing system for adapting a digital assistant experience, the method comprising: presenting, by the computing system, a first digital assistant experience at a client device based on a first detected distance of a user from reference point that relates to the client device; determining that the user moves a threshold distance to cause a change from the first detected distance to a second detected distance from the reference point; and adapting, by the computing system, an element of the first digital assistant experience to generate a second digital assistant experience at the client device that is based on a difference between the first detected distance and the second detected distance.

In addition to any of the above described methods, any one or combination of: wherein the first detected distance and the second detected distance are detected via one or more sensors of the client device; wherein the first detected distance and the second detected distance pertain to different pre-defined proximity zones that are defined in relation to the reference point; further comprising, prior to said presenting the first digital assistant experience, causing the client device to transition from a low-power mode to an active state responsive to detecting presence of the user at the first detected distance from the reference point; wherein the first detected distance is greater than the second detected distance, and the element of the first digital assistant experience comprise an interaction modality for interacting with the digital assistant; further comprising: ascertaining that the user moves a particular distance away from the reference point; and causing, responsive to said ascertaining, one or more aspects of the second digital assistant experience to be transferred to a different device such that content that is output at the client device as part of the second digital assistant experience is output at the different device.

A method implemented by a computing system for modifying a user experience based on an identity of a user, the method comprising: detecting user presence using sensor data collected via one or more sensors of the computing system; invoking, by the computing system, a digital assistant to provide a first user experience for interactivity with the digital assistant; determining an identity of the user; and modifying, by the computing system, the first user experience to generate a second user experience that includes identity-specific information that is linked to the identity of the user.

In addition to any of the above described methods, any one or combination of: wherein said determining the identity of the user is based on further sensor data collected via the one or more sensors of the computing system; wherein the first user experience includes an assistant query without identity-specific information for the identity of the user.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A system comprising:
a processing system; and
computer readable media storing instructions that are executable by the processing system to cause the system to perform operations including:
presenting, at a client device, a first digital assistant experience for interactivity with a digital assistant based on a first detected distance of a user from a reference point that relates to the client device;
determining that the user moves a threshold distance to cause a change from the first detected distance to a second detected distance from the reference point; and
adapting an element of the first digital assistant experience to generate a second digital assistant experience at the client device that is based on a change in a contextual factor that results from the user moving from the first detected distance to the second detected distance from the reference point.

2. A system as described in claim 1, wherein the operations further include, prior to said presenting the first digital assistant experience, causing the client device to transition from a low-power mode to an active state responsive to detecting presence of the user.

3. A system as described in claim 1, wherein the reference point comprises one or more of the client device or a display device of the client device.

4. A system as described in claim 1, wherein the first detected distance is greater than the second detected distance, and the contextual factor comprises an estimated viewing distance of the user from a display device of the client device.

5. A system as described in claim 1, wherein the first detected distance is greater than the second detected distance, the contextual factor comprises an estimated viewing distance of the user from a display device of the client device, and the element of the first digital assistant experience comprises an interaction modality for interacting with the digital assistant.

6. A system as described in claim 1, wherein the first detected distance is greater than the second detected distance, the contextual factor comprises an estimated viewing distance of the user from a display device of the client device, and wherein adapting the element of the first digital assistant experience comprises increasing a font size of the element.

7. A system as described in claim 1, wherein the contextual factor comprises an indication of whether an identity of the user is known.

8. A system as described in claim 1, wherein said adapting further comprises adapting the element of the first digital assistant experience based on an indication regarding the user's emotional state.

9. A system as described in claim 1, wherein the element of the first digital assistant experience comprises an input mode of the digital assistant, and said adapting comprises switching between an audio interaction mode and a visual interaction mode for interaction with the digital assistant.

10. A system as described in claim 1, wherein the element of the first digital assistant experience comprises a visual user interface of the digital assistant, and said adapting comprises adapting an aspect of the visual user interface including one or more of changing a font size, a graphic, a color, or a contrast of the visual user interface in dependence upon the change in the contextual factor.

11. A system as described in claim 1, wherein the operations further include:
ascertaining that the user moves a particular distance away from the reference point; and
causing, responsive to said ascertaining, one or more aspects of the second digital assistant experience to be transferred to a different device.

12. A method implemented by a computing system, the method comprising:
presenting, by the computing system, a first digital assistant experience at a client device based on a first detected distance of a user from reference point that relates to the client device;
determining that the user moves a threshold distance to cause a change from the first detected distance to a second detected distance from the reference point; and
adapting, by the computing system, an element of the first digital assistant experience to generate a second digital assistant experience at the client device that is based on a difference between the first detected distance and the second detected distance.

13. A method as described in claim 12, wherein the first detected distance and the second detected distance are detected via one or more sensors of the client device.

14. A method as described in claim 12, wherein the first detected distance and the second detected distance pertain to different pre-defined proximity zones that are defined in relation to the reference point.

15. A method as described in claim 12, further comprising, prior to said presenting the first digital assistant experience, causing the client device to transition from a low-power mode to an active state responsive to detecting presence of the user at the first detected distance from the reference point.

16. A method as described in claim 12, wherein the first detected distance is greater than the second detected distance, and the element of the first digital assistant experience comprise an interaction modality for interacting with the digital assistant.

17. A method as described in claim 12, further comprising:
ascertaining that the user moves a particular distance away from the reference point; and
causing, responsive to said ascertaining, one or more aspects of the second digital assistant experience to be transferred to a different device such that content that is output at the client device as part of the second digital assistant experience is output at the different device.

18. A method implemented by a computing system, the method comprising:
detecting user presence using sensor data collected via one or more sensors of the computing system;
invoking, by the computing system, a digital assistant to provide a first user experience for interactivity with the digital assistant;
determining an identity of the user; and
modifying, by the computing system, the first user experience to generate a second user experience that includes identity-specific information that is linked to the identity of the user.

19. A method as described in claim 18, wherein said determining the identity of the user is based on further sensor data collected via the one or more sensors of the computing system.

20. A method as described in claim 18, wherein the first user experience includes an assistant query without identity-specific information for the identity of the user.
